(19) United States
(12) Patent Application Publication
(10) Pub. No.: US 2018/0211230 A1
(43) Pub. Date: Jul. 26, 2018

(54) INFORMATION PROCESSING APPARATUS, INFORMATION PROCESSING METHOD, AND COMPUTER-READABLE STORAGE MEDIUM

(71) Applicant: DENSO TEN Limited, Kobe-shi (JP)

(72) Inventors: Hironori ICHIOKA, Kobe-shi (JP); Shinichi TANAKA, Kobe-shi (JP)

(73) Assignee: DENSO TEN Limited, Kobe-shi (JP)

(21) Appl. No.: 15/876,591

(22) Filed: Jan. 22, 2018

(30) Foreign Application Priority Data
Jan. 26, 2017 (JP) 2017-012316

(51) Int. Cl. G06Q 10/10; G06N 5/02

(52) U.S. Cl. CPC G06Q 10/1095; G06F 17/30864; G06N 5/022

(57) ABSTRACT

An information providing apparatus according to an embodiment includes an acquisition unit, an extraction unit, a determination unit, and a proposal unit. The acquisition unit acquires plan information on a plan of a user. The extraction unit extracts one or more events. The one or more events are able to be performed by a start time point of the plan in the plan information acquired by the acquisition unit. The determination unit determines, on the basis of a type of the plan in the plan information acquired by the acquisition unit, whether or not performances of the one or more events extracted by the extraction unit are appropriate for carrying out the plan. The proposal unit proposes at least one event among the extracted one or more events to the user on the basis of a result determined by the determination unit.

### CROSS-REFERENCE TO RELATED APPLICATION

This application is based upon and claims the benefit of priority of the prior Japanese Patent Application No. 2017-012316, filed on Jan. 26, 2017 the entire contents of which are incorporated herein by reference.

### FIELD

The embodiment discussed herein is directed to an information processing apparatus, an information processing method, and a computer-readable storage medium.

### BACKGROUND

Conventionally, there is known an information providing apparatus that proposes a new event to a user on the basis of plan information on a plan registered by the user, for example. The information providing apparatus proposes an event that is able to be performed by a start time point of the next plan, for example (see Japanese Laid-open Patent Publication No. 2013-002844, for example).

However, the conventional technology merely proposes in terms of time an event that is in time for the next plan, and whether or not the proposed event is an obstacle to the next plan is not considered. Thus, there conventionally exists a possibility that a low reliable event is proposed to a user that may cause a problem to the next plan.

### SUMMARY

An information providing apparatus according to an embodiment includes an acquisition unit, an extraction unit, a determination unit, and a proposal unit. The acquisition unit acquires plan information on a plan of a user. The extraction unit extracts one or more events. The one or more events are able to be performed by a start time point of the plan in the plan information acquired by the acquisition unit. The determination unit determines, on the basis of a type of the plan in the plan information acquired by the acquisition unit, whether or not performances of the one or more events extracted by the extraction unit are appropriate for carrying out the plan. The proposal unit proposes at least one event among the extracted one or more events to the user on the basis of a result determined by the determination unit.

### BRIEF DESCRIPTION OF DRAWINGS

A more complete appreciation of the disclosed technology and many of the attendant advantages thereof will be readily obtained as the same becomes better understood by reference to the following detailed description when considered in connection with the accompanying drawings, wherein:

FIG. 1 is a diagram illustrating the outline of an information providing method according to an embodiment;

FIG. 2 is a block diagram illustrating a configuration of an information providing apparatus according to the embodiment;

FIG. 3 is a diagram illustrating plan information;

FIG. 4 is a diagram illustrating custom information;

FIG. 5 is a diagram illustrating event list information;

FIG. 6 is a diagram illustrating correspondence information;

FIG. 7 is a diagram illustrating adequacy evaluation;

FIG. 8 is a flowchart illustrating a procedure for proposal process to be executed by the information providing apparatus according to the embodiment; and

FIG. 9 is a block diagram illustrating a configuration of an information providing system according to a modification.

### DESCRIPTION OF EMBODIMENT

Hereinafter, an information providing apparatus, an information providing method, and a computer-readable storage medium disclosed in the present application will be described in detail with reference to the accompanying drawings. Moreover, an embodiment described below is merely one example, and not intended to limit the present disclosure.

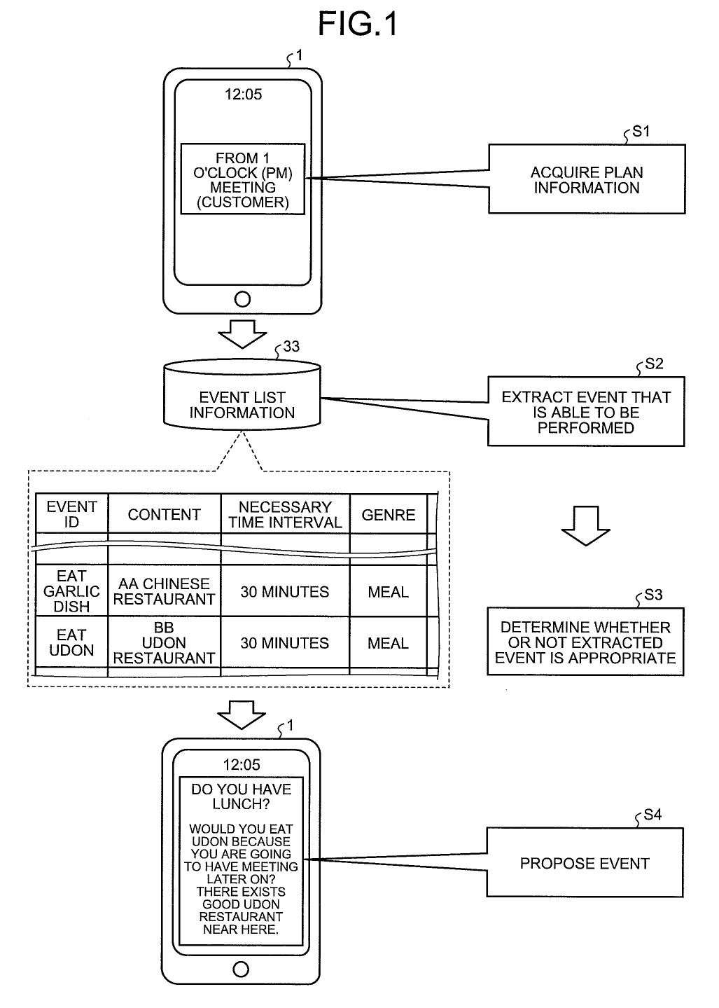

First, the outline of the information providing method according to the embodiment will be explained with reference to FIG. 1. FIG. 1 is a diagram illustrating the outline of the information providing method according to the embodiment. In FIG. 1, a portable terminal such as a smartphone is illustrated as one example of an information providing apparatus 1 according to the embodiment. On a screen (see upper part of FIG. 1) of the information providing apparatus 1, a reminder image is displayed indicating that a start time point of the next plan of a user, who is an owner of the information providing apparatus 1, is coming close.

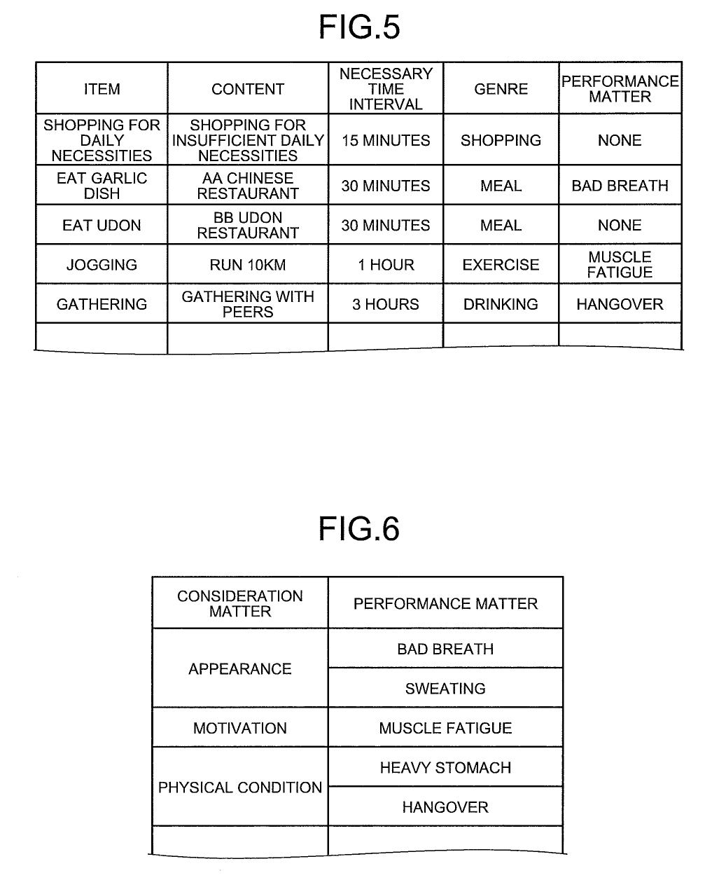

In FIG. 1, for example, event list information 33 including information on events that the user wants to perform in the future is illustrated. Details of the event list information 33 will be mentioned later with reference to FIG. 5.

In the information providing method according to the embodiment, for example, an event that is able to be performed by the next plan of the user is extracted from the event list information 33, and whether or not a proposal of the extracted event to the user is appropriate is further determined, so as to make a proposal of the event on the basis of a determined result.

Meanwhile, a conventional information providing method will be explained. In the conventional information providing method, for example, an event is proposed that is able to be performed during an unoccupied time period until a start time point of the next plan. However, conventionally, an event that can be completed before the next plan is merely proposed in terms of time, and whether or not the proposed event causes a problem to the next plan is not considered.

For example, when a lunch is proposed to a user who is going to have a meeting with a customer later on, an event of eating garlic dish (e.g. gyoza) is proposed among pieces of event list information, and thus there exists a case where it is difficult for the user caring his/her appearance, such as the breath, to accept the proposed event. In other words, conventionally, there exists a possibility that a low reliable event that may cause a problem to the next plan is proposed to the user.

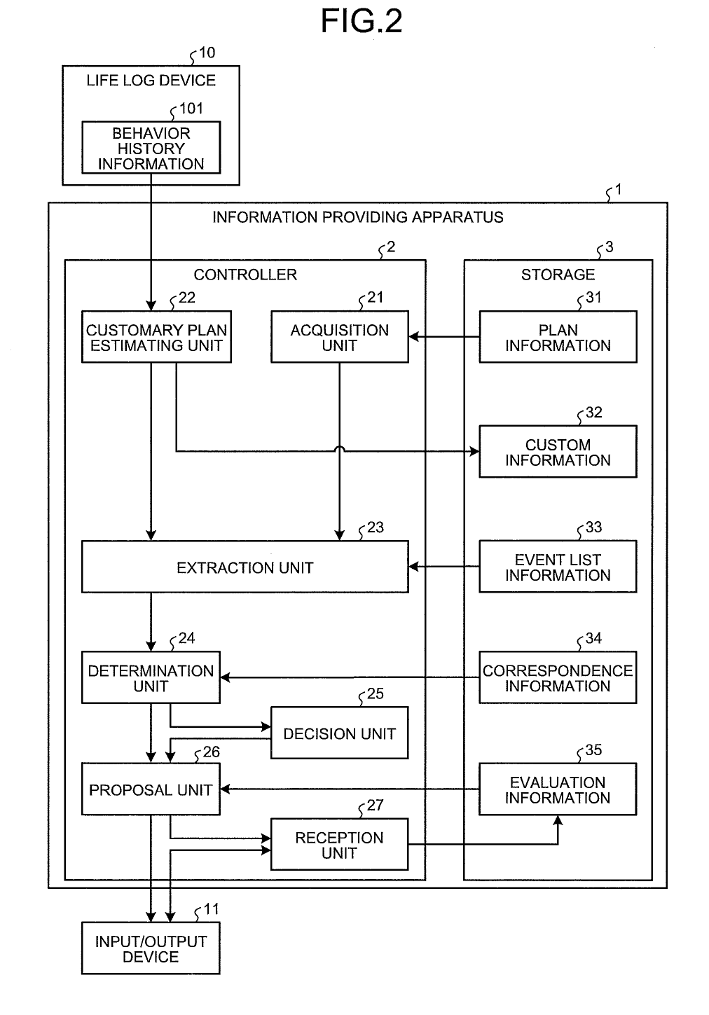

Therefore, in the information providing method according to the embodiment, such an event that does not cause a problem to the next plan is to be proposed among events that are able to be performed in terms of time. Specifically, the information providing apparatus 1 according to the embodiment acquires plan information 31 (see FIG. 2) on a plan of the user (Step S1).

Subsequently, in the information providing method according to the embodiment, one or more events are extracted that are able to be performed by a start time point of the plan in the acquired plan information 31 (Step S2). Assume that “eat garlic dish” and “eat udon (wheat-flour noodles)” are extracted from the event list information 33.

Next, the information providing apparatus 1 according to the embodiment determines whether or not performances of the extracted events are appropriate for carrying out the plan in the acquired plan information 31 on the basis of a type of the plan (Step S3).

For example, because the type of the next plan is a meeting, with regarding to “eat garlic dish” and “eat udon”, “eat garlic dish” that causes bad breath is determined to be inappropriate, and “eat udon” that does not affect the appearance, such as breath, is determined to be appropriate.

The information providing apparatus 1 according to the embodiment proposes an event to the user on the basis of the determined result (Step S4). For example, as illustrated in FIG. 1, information on an event associated with “eat udon” is displayed on the screen (see lower part of FIG. 1) of the information providing apparatus 1.

In other words, in the information providing method according to the embodiment, among events that are able to be performed in terms of time, such an event (for example, “eat garlic dish” etc.) that may cause a problem to the next plan is excluded from a proposal candidate. Therefore, it is possible to propose, to the user, a high reliable event that does not cause a problem to the next plan.

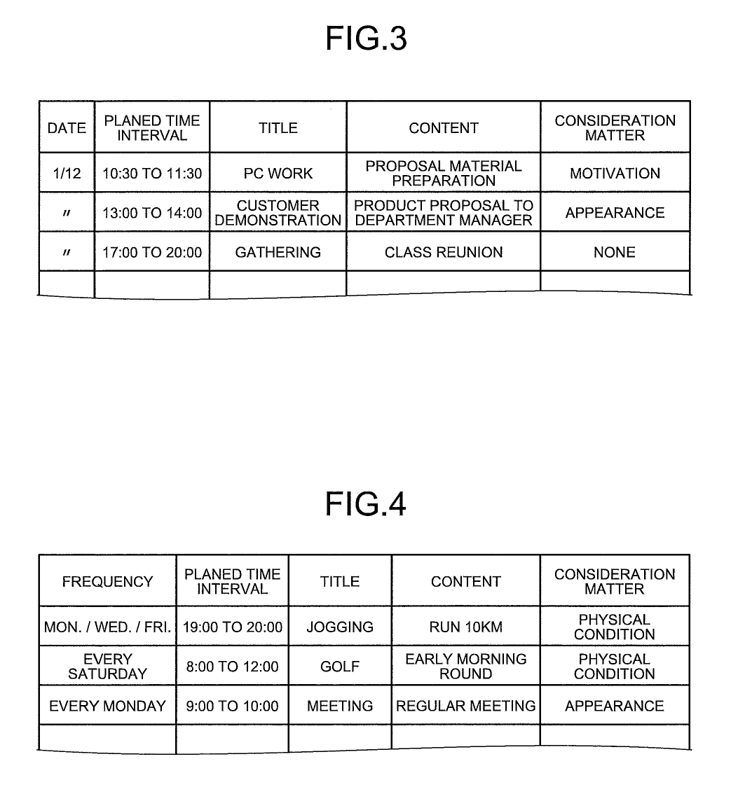

The information providing apparatus 1 according to the embodiment performs the determination on the basis of: information, included in the plan information 31, on a matter (appearance etc.) to be considered; and information, included in the event list information 33, on a matter (bad breath etc.) that will occur in association with performance of the event, and details thereof will be mentioned later with reference to FIG. 3 and the like.

The information providing apparatus 1 according to the embodiment extracts a habituated behavior from a past-behavior history of the user so as to estimate the habituated behavior to be the above-mentioned plan. This point will be mentioned later with reference to FIG. 4.

Next, details of a configuration of the information providing apparatus 1 according to the embodiment will be explained with reference to FIG. 2. FIG. 2 is a block diagram illustrating the configuration of the information providing apparatus 1 according to the embodiment. As illustrated in FIG. 2, the information providing apparatus 1 according to the embodiment is connected with a life log device 10 and an input/output device 11. First, configurations of devices other than the information providing apparatus 1 will be explained.

The life log device 10 is an electronic device that records, as behavior history information 101, behaviors, biological information, etc. of the user on the basis of information sent from various sensors. For example, the life log device 10 detects a motion of the user on the basis of information sent from a motion sensor so as to record a behavior of the user.

For example, the life log device 10 records biological information such as a pulse, a respiration, a blood pressure, and a body temperature. Moreover, the life log device 10 acquires position information of the user from a Global Positioning System satellite (GPS satellite) etc. and records the acquired position information in association with behaviors and biological information of the user.

The input/output device 11 is an electronic device having an input function and an output function of, for example, a touch-panel display among other things. The input/output device 11 acquires, for example, event information to be proposed to the user from the information providing apparatus 1 so as to display the information on a display (not illustrated).

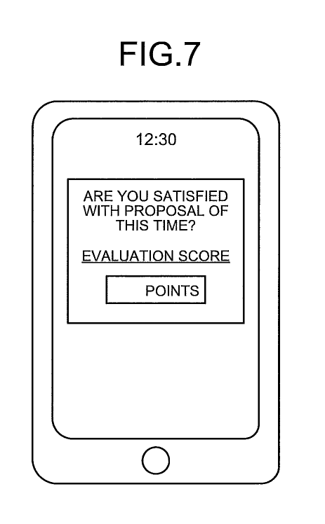

The input/output device 11 displays a display screen for receiving an adequacy evaluation of a proposed event, and outputs, to the information providing apparatus 1, information according to a user operation made by the user with this display screen. This point will be mentioned later with reference to FIG. 7.

Next, the information providing apparatus 1 according to the embodiment will be explained. The information providing apparatus 1 according to the embodiment includes a controller 2 and a storage 3. The controller 2 includes an acquisition unit 21, a customary plan estimating unit 22, an extraction unit 23, a determination unit 24, a decision unit 25, a proposal unit 26, and a reception unit 27. The storage 3 stores the plan information 31, custom information 32, the event list information 33, correspondence information 34, and evaluation information 35.

The information providing apparatus 1 includes: a computer including, for example, a Central Processing Unit (CPU), a Read Only Memory (ROM), a Random Access Memory (RAM), a Hard Disk Drive (HDD), and an input/output port among other things; and various circuits.

The CPU of the computer reads and executes, for example, a program stored in the ROM so as to function as the acquisition unit 21, the customary plan estimating unit 22, the extraction unit 23, the determination unit 24, the decision unit 25, the proposal unit 26, and the reception unit 27 of the controller 2.

At least one or all of the acquisition unit 21, the customary plan estimating unit 22, the extraction unit 23, the determination unit 24, the decision unit 25, the proposal unit 26, and the reception unit 27 of the controller 2 may be constituted of hardware such as an Application Specific Integrated Circuit (ASIC) and a Field Programmable Gate Array (FPGA).

The storage 3 corresponds to, for example, the RAM and the HDD. The RAM and the HDD store the plan information 31, the custom information 32, the event list information 33, the correspondence information 34, the evaluation information 35, and information on various programs among other things. The information providing apparatus 1 may acquire the above-mentioned programs and various kinds of information via another computer or a portable recording medium that are connected by a wired or wireless network.

The plan information 31, the custom information 32, the event list information 33, and the correspondence information 34, which are stored in the storage 3, will be explained with reference to FIGS. 3 to 6. The evaluation information 35 will be mentioned later.

First, the plan information 31 will be explained with reference to FIG. 3. FIG. 3 is a diagram illustrating the plan information 31. In FIG. 3, one example of the plan information 31 is illustrated. The plan information 31 is information on plans previously registered by a user operation, for example.

As illustrated in FIG. 3, the plan information 31 includes types of a plan, such as “date”, “planed time interval”, “title”, “content”, and “consideration matter”. The “date” indicates the date when the plan of the user is carried out.

The “planed time interval” indicates an estimated time interval from a start time point to an end time point of the plan. The “title” indicates a title of the plan. The “content” indicates a content of the plan. The “consideration matter” is information (hereinafter, may be referred to as “consideration information”) on a matter to be considered in carrying out the plan.

For example, as illustrated in FIG. 3, when a title is “customer demonstration”, a consideration matter is “appearance”. This means that appearance is to be taken care of so as not to be rude to a customer to which a product is proposed.

In other words, “consideration matter” indicates a point that the user is to take care of in carrying out a plan, for example. The “consideration matter” is a determination reference for the determination unit 24, along with “performance matter” (see FIG. 5) that will be mentioned later. This point will be mentioned later.

The “consideration matter” is manually selected to be registered by the user among from a plurality of options of consideration matters when the user registers a plan, for example. The options of the consideration matters may include only predetermined consideration matters, or may include one or more consideration matters that are generated by the user him/herself.

The “consideration matter” is not limited to a matter that is manually selected by the user. A matter may be registered that is automatically generated on the basis of, for example, “date”, “planed time interval”, “title”, “content”, etc. When a consideration matter is automatically generated, or when a new performance matter is generated by the user him/herself, the generated new consideration matter is to be included in the correspondence information 34 that will be mentioned later.

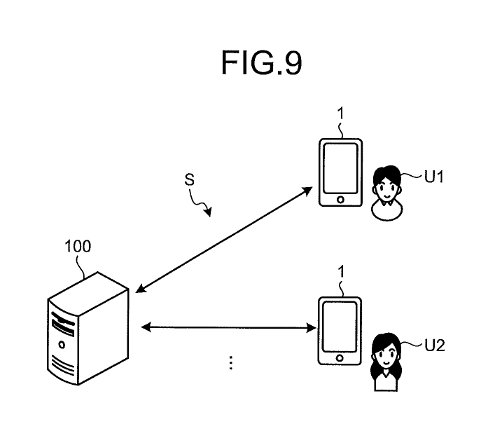

This embodiment explains the case in which a plan of the user who is an owner of the information providing apparatus 1 is only registered on the plan information 31. However, the plan information 31 may be shared with another user, for example. This point will be mentioned later with reference to FIG. 9.

Next, the custom information 32 will be explained with reference to FIG. 4. FIG. 4 is a diagram illustrating the custom information 32. In FIG. 4, one example of the custom information 32 is illustrated. The custom information 32 is generated by the customary plan estimating unit 22 that will be mentioned later.

As illustrated in FIG. 4, the custom information 32 includes items such as “frequency”, “planed time interval”, “title”, “content”, and “consideration matter”. The “frequency” indicates the frequency at which a habituated behavior is performed in the past. The “planed time interval”, “title”, “content”, and “consideration matter” have been already described (see FIG. 3), and thus description thereof is omitted.

Next, the event list information 33 will be explained with reference to FIG. 5. FIG. 5 is a diagram illustrating the event list information 33. In FIG. 5, one example of the event list information 33 is illustrated. The event list information 33 includes information on events (what user wants to eat and what user wants to buy) that the user wants to perform, for example, and is information previously registered by a user operation.

As illustrated in FIG. 5, the event list information 33 includes, for example, “item”, “content”, “necessary time interval”, “genre”, and “performance matter”.

The “item” indicates an item name of an event. The “content” indicates a content of the event. The “necessary time interval” indicates a time interval needed for performing the event. The “genre” indicates a classified content of the event. The “performance matter” indicates information (hereinafter, may be referred to as “performance information”) on a matter associated with performance of the event.

For example, as illustrated in FIG. 5, when an item of an event is “eat garlic dish”, a performance matter is “bad breath”. This indicates that there exists a concern that breath of the user becomes bad when the user eats garlic dish.

In other words, the “performance matter” indicates a physical or mental state of the user that is changed by performance of an event, for example. When registering an event, for example, the user manually selects a “performance matter” among from a plurality of options of performance matters so as to register the selected “performance matter” in the event list information 33. The options of the performance matters may be only predetermined performance matters, or may include one or more performance matters that are generated by the user him/herself.

The “performance matter” is not limited to be manually selected by the user. For example, a matter may be registered that is automatically generated on the basis of “item”, “content”, “necessary time interval”, and “genre” among other things.

The event list information 33 is explained to be information that is previously registered by the user. For example, the event list information 33 may be acquired from a server device (not illustrated) and the like. The event list information 33 may be information of a list (namely, to-do list) of things that need to be done by the user, for example.

Next, the correspondence information 34 will be explained with reference to FIG. 6. FIG. 6 is a diagram illustrating the correspondence information 34. One example of the correspondence information 34 is illustrated in FIG. 6. The correspondence information 34 is information that is previously registered by the user operation, for example.

As illustrated in FIG. 6, the correspondence information 34 indicates correspondence relations between the “consideration matters” (see FIG. 3 and the like) and the “performance matters” (see FIG. 5). As illustrated in FIG. 6, for example, “bad breath” and “sweat” of the performance matter correspond to “appearance” of the consideration matter.

In the correspondence information 34, a correspondence relation between each “performance matter” and corresponding “consideration matter” is decided by a manual operation of the user, for example. The correspondence relation may be automatically decided on the basis of attributes of the consideration matters and the performance matters, for example.

Next, the controller 2 will be explained. The controller 2 acquires the plan information 31, extracts an event that is able to be performed by a start time point of a plan of the user, and determines whether or not performance of the extracted event is appropriate to carry out the plan, so as to propose the event to the user on the basis of a determined result.

The acquisition unit 21 acquires the plan information 31 on a plan of the user. The acquisition unit 21 may acquire the plan information 31 that is previously stored in the storage 3, or may acquire the plan information 31 from a server device 100 (see FIG. 9), for example. This point will be mentioned later with reference to FIG. 9.

The customary plan estimating unit 22 acquires the behavior history information 101, which is a past-behavior history recorded by the user, so as to estimate the custom information 32 on a habituated behavior of the user as a plan.

Specifically, the customary plan estimating unit 22 estimates a habituated behavior of the user on the basis of the behavior history information 101 recorded in the life log device 10 so as to generate the custom information 32. In other words, the customary plan estimating unit 22 may extract a behavior that was regularly performed by the user in the past as a habituated behavior, so as to estimate the extracted behavior as a plan of the user.

Hence, the proposal unit 26 that will be mentioned later proposes an appropriate event to be able to smoothly perform a habituated behavior of the user. The customary plan estimating unit 22 outputs, to the extraction unit 23, the custom information 32 indicating the estimated plan, so as to store the custom information 32 in the storage 3.

The extraction unit 23 extracts an event that is able to be performed by a start time point of the plan in the plan information 31 acquired by the acquisition unit 21. Specifically, the extraction unit 23 first acquires a start time point of the next plan from the plan information 31 or the custom information 32.

Next, the extraction unit 23 extracts an event that is able to be performed by a start time point of the next plan on the basis of “necessary time interval” of the event list information 33. The above described “to be able to be performed by a start time point” indicates that the next plan is punctually carried out from the start time point thereof.

In other words, the extraction unit 23 considers, for example, travelling time that is taken for moving to a location of the next plan and the like. In other words, even in a case where a remaining time interval until the start time point of the next plan is equal to or more than “necessary time interval” of an event, when the possibility that the user is not able to arrive at the location of the next plan by the start time point is high, the extraction unit 23 does not extract the event.

Moreover, the extraction unit 23 may extract an event on the basis of “genre”. Specifically, in a case where a present time point is within a time range appropriate for lunch or the like, the extraction unit 23 extracts an event having a genre of “meal”. On the other hand, in a case where a present time point is outside the time range appropriate for meal, the extraction unit 23 excludes an event having a genre of “meal” from events to be extracted.

The extraction unit 23 may extract one event, or may extract two or more events so that the user is able to select one or more events among from the extracted events. The extraction unit 23 may combine together a plurality of events.

The determination unit 24 determines whether or not performance of the event extracted by the extraction unit 23 is appropriate for the user to carry out the plan. Specifically, the determination unit 24 performs the determination on the basis of the consideration information, which is information on matters to be considered in the plan information 31, and the performance information that is information on matters accompanied with performance of the events in the event list information 33.

For example, assume that the next plan of the user is “customer demonstration” to be started from 1 o'clock (PM) (see FIG. 3). Further assume that the extraction unit 23 extracts “eat garlic dish” and “eat udon” (hereinafter, both of them may be collectively referred to as “extracted events”, see FIG. 5).

In this case, the determination unit 24 performs determination with reference to the correspondence information 34. Specifically, the determination unit 24 determines, on the basis of the correspondence information 34, whether or not the “performance matters” of the extracted events correspond to “consideration matter” of the “customer demonstration” in the plan information 31.

For example, in a case of “eat garlic dish”, “bad breath” of the performance matter corresponds to “appearance” of the consideration matter. In other words, when the performance matter and the consideration matter correspond to each other, the determination unit 24 determines that performance of the event of “eat garlic dish” is inappropriate for carrying out the plan.

Thus, the proposal unit 26 that will be mentioned later does not propose the event of “eat garlic dish” to the user, so that a case is prevented in which the user eats garlic dish before the “customer demonstration” to have bad breath. In other words, an event, which causes a problem to the next plan, is able to be excluded from events to be proposed, so that it is possible to improve the reliability of an event to be proposed.

In a case of “eat udon”, there exists no performance matter. Therefore, the “eat udon” does not correspond to “appearance” of the consideration matter. In other words, when the performance matter and the consideration matter do not correspond to each other, the determination unit 24 determines that performance of an event of “eat udon” is appropriate for carrying out the plan.

The event, which is determined to be inappropriate by the determination unit 24, is explained not to be proposed by the proposal unit 26. When a plurality of events is to be proposed, there exists a case where the event is proposed in a low preference order of the proposal. This point will be mentioned later.

In the above description, the determination process of the determination unit 24 is explained when the performance matter of the event list information 33 is a negative effect. However, the determination process is able to be also performed when the performance matter is a positive effect (for example, refresh his/her mind by coffee break and the like).

In this case, the determination unit 24 determines that performance of an event is appropriate for carrying out the plan when a performance matter of positive effects corresponds to a consideration matter. The determination unit 24 outputs the determined result to the decision unit 25 and the proposal unit 26.

When the extraction unit 23 extracts a plurality of events, the decision unit 25 decides, for each of the events, a preference order on the basis of the result determined by the determination unit 24. Specifically, the decision unit 25 lowers a preference order of an event that is determined to be inappropriate by the determination unit 24. On the other hand, the decision unit 25 heightens the preference order of an event that is determined to be appropriate by the determination unit 24.

Thus, the proposal unit 26, mentioned later, proposes only one or more events having high preference orders to the user even when the plurality of events is extracted.

For example, when there exists no event that is determined to be appropriate, not only one or more events having low preference orders are proposed, but also the user may be informed of the fact that their preference orders are low. Thus it is possible to improve the reliability of one or more events to be proposed.

In a case where an event is determined to be inappropriate by the determination unit 24, when a performance matter of the event is able to be resolved, the decision unit 25 may heighten its preference order.

For example, in a case of “eat garlic dish”, when there exists a restaurant which serves gyoza that relatively less affects breath (for example, restaurant that serves gyoza with little or without garlic etc.) other than “AA Chinese restaurant” and the like, the decision unit 25 heighten its preference order. Information on the restaurant is able to be acquired by searching the Internet for its web-site, for example.

For example, when a time interval from a time point of an event of “eat garlic dish” to a start time point of the next plan is equal to or more than a predetermined time interval (for example, three hours), the decision unit 25 may heighten the preference order of the event. This is because bad breath caused by garlic dish is eased after a certain time interval elapsed.

In this manner, in a case where a performance matter of an event is able to be resolved, when a preference order of a proposal is heightened, it is possible to perform a proposal having various options. The decision unit 25 outputs information on the decided preference order to the proposal unit 26.

The proposal unit 26 proposes one or more events to the user on the basis of the result determined by the determination unit 24. Specifically, the proposal unit 26 proposes, to the user, one or more events that are determined to be appropriate by the determination unit 24. On the other hand, the proposal unit 26 excludes, from events to be proposed, an event determined to be inappropriate by the determination unit 24. Thus, it is possible to prevent an inappropriate event from being proposed.

The proposal unit 26 may propose an event which has been determined to be inappropriate by the determination unit 24, on the basis of the preference order decided by the decision unit 25.

The proposal unit 26 may consider an event that has been proposed in the past. Specifically, the proposal unit 26 accumulates proposed events that the user has carried out before a predetermined plan. When the same plan exists at a later time, the proposal unit 26 preferentially proposes the event carried out by the user before the plan.

For example, when the next plan is “customer demonstration”, a fact indicating that the user frequently eats udon is accumulated, the proposal unit 26 preferentially proposes “eat udon”.

The proposal unit 26 is explained to consider the next plan in order to propose an event. For example, an event may be proposed additionally in consideration of a previous plan, and an event may be proposed in consideration of a plan after the next plan.

The proposal unit 26 is able to propose an event on the basis of adequacy evaluation, mentioned later, received by the reception unit 27. This point will be mentioned later with reference to FIG. 7.

When the proposal unit 26 proposes an event, the reception unit 27 receives adequacy evaluation for this event from the user. The adequacy evaluation is a degree of appropriateness of the event proposed to the user. The adequacy evaluation will be here explained with reference to FIG. 7.

FIG. 7 is a diagram illustrating the adequacy evaluation. In FIG. 7, a screen for receiving the adequacy evaluation is displayed on the information providing apparatus 1 such as a smartphone. This screen is displayed after a predetermined time interval from a proposal performed by the proposal unit 26, for example.

As illustrated in FIG. 7, the user inputs an evaluation score to the displayed picture. The reception unit 27 receives the input evaluation score as the adequacy evaluation, and stores the score in the storage 3 as the evaluation information 35, for example.

The proposal unit 26 proposes an event on the basis of the adequacy evaluation received by the reception unit 27. For example, when the evaluation score of an event in the evaluation information 35 stored in the storage 3 is equal to or less than a predetermined score, the proposal unit 26 excludes the event from events to be proposed for a similar plan at a later time.

In other words, the evaluation of the user is able to be fed back and reflected on a proposal of an event at the later time, and thus it is possible to propose a high reliable event.

When the proposal unit 26 proposes a plurality of events, the reception unit 27 may receive an evaluation score for each of the events. In other words, the reception unit 27 receives adequacy evaluation for one or more events that are not performed by the user among the plurality of proposed events.

Specifically, the reception unit 27 receives, via the user operation, an event that has been performed, among the plurality of events proposed by the proposal unit 26, and further receives the above-mentioned one or more evaluation scores.

In this case, for example, reasons (for example, not performed at this time, however, may be performed in another kind of situation, etc.) for which the event has not been performed are input with respect to one or more events that have not been performed by the user. In this manner, adequacy evaluation of an event is received that is not performed by the user, so that it is possible to improve the reliability of an event proposed at the later time by reflecting the evaluation.

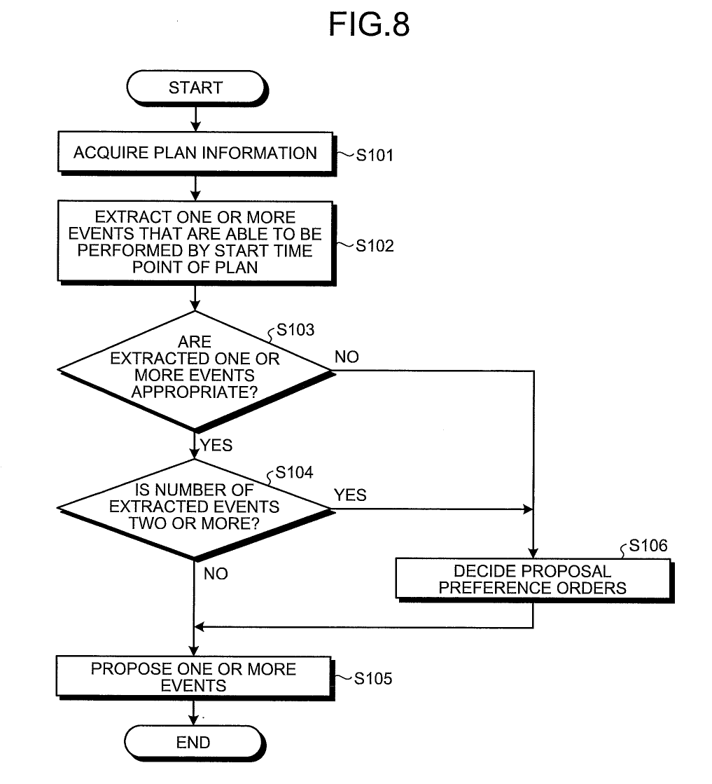

Next, with reference to FIG. 8, a procedure for the proposal process to be executed by the information providing apparatus 1 according to the embodiment will be explained. FIG. 8 is a flowchart illustrating the procedure for the proposal process to be executed by the information providing apparatus 1 according to the embodiment.

As illustrated in FIG. 8, first, the acquisition unit 21 acquires the plan information 31 on a plan of a user (Step S101). Subsequently, the extraction unit 23 extracts one or more events that are able to be performed by a start time point of the plan (Step S102).

Next, the determination unit 24 determines, on the basis of a type of the plan in the plan information 31 acquired by the acquisition unit 21, whether or not performance of the one or more events extracted by the extraction unit 23 is appropriate for carrying out the plan (Step S103).

When the determination unit 24 determines that the performance of the one or more events is appropriate for carrying out the plan (Step S103: Yes), the decision unit 25 determines whether or not the number of the extracted events is two or more (Step S104).

When the number of the extracted events is not two or more, in other words, the number of the extracted events is one (Step S104: No), the proposal unit 26 proposes this event (Step S105), and terminates the process.

On the other hand, in Step S103, when the determination unit 24 determines that the performance of the one or more events is inappropriate for carrying out the plan (Step S103: No), the decision unit 25 lowers proposal preference orders of the one or more events to perform the decision (Step S106).

In Step S104, the number of the extracted events is two or more (Step S104: Yes), a preference order is decided for each of the events (Step S106).

As described above, the information providing apparatus 1 according to the embodiment includes the acquisition unit 21, the extraction unit 23, the determination unit 24, and the proposal unit 26. The acquisition unit 21 acquires the plan information 31 on a plan of the user. The extraction unit 23 extracts one or more events. The one or more events are able to be performed by a start time point of the plan in the plan information 31 acquired by the acquisition unit 21. The determination unit 24 determines whether or not performances of the one or more events extracted by the extraction unit 23 are appropriate for carrying out the plan, on the basis of a type of the plan in the plan information 31 acquired by the acquisition unit 21. The proposal unit 26 proposes at least one event among the extracted one or more events to the user, on the basis of a result determined by the determination unit 24. Thus, such a low reliable event that may cause a problem to the next plan is not proposed to the user, so that it is possible to propose a high reliable event.

In the above-mentioned embodiment, the case is explained in which the information providing apparatus 1 is a portable terminal such as a smartphone; however, the information providing apparatus 1 may be a car navigation apparatus, for example. In this case, a plan in the plan information 31 may be a set destination and the one or more events in the event list information 33 may be stopovers, for example.

In the above-mentioned embodiment, for example, the plan information 31 includes only plans of the user owning the information providing apparatus 1; however, the plan information 31 of a plurality of users may be shared, for example. This point will be explained with reference to FIG. 9.

FIG. 9 is a block diagram illustrating a configuration of an information providing system S according to a modification of the embodiment. As illustrated in FIG. 9, the information providing system S includes a server device 100 and a plurality of information providing apparatuses 1. The plurality of information providing apparatuses 1 is respectively associated with different users U1 and U2. The plurality of information providing apparatuses 1 are able to be divided in units of, for example, families, companies, friend groups, etc.

For example, each of the information providing apparatuses 1 transmits the plan information 31 and the event list information 33 to the server device 100. The server device 100 centrally manages the plan information 31 and the event list information 33 of each of the information providing apparatuses 1. The server device 100 proposes one or more events to each of users U1 and U2 of the corresponding information providing apparatus 1 on the basis of the plan information 31 and the event list information 33 that are centrally managed by the server device 100.

For example, in a case where the users U1 and U2 are a family and have a same free time interval, the server device 100 proposes a same event (for example, meal) to the users U1 and U2. In this manner, by employing the information providing system S, it is possible to propose an event in consideration of plans of the plurality of users U1 and U2.

For example, an event that has been performed by one of the users U1 and U2 may be shared with the other of the users U1 and U2. For example, assume that “shopping for daily necessities” is included in the event list information 33 of the user U1 and the user U2.

Assume that the user U1 has performed “shopping for daily necessities”. In this case, the server device 100 lowers the preferential degree of “shopping for daily necessities” in the event list information 33 of the other user U2. Thus, it is possible to prevent the users U1 and U2 from performing a same event.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information providing apparatus comprising:
an acquisition unit that acquires plan information on a plan of a user;
an extraction unit that extracts one or more events, the one or more events being able to be performed by a start time point of the plan in the plan information acquired by the acquisition unit;
a determination unit that determines, based on a type of the plan in the plan information acquired by the acquisition unit, whether or not performances of the one or more events extracted by the extraction unit are appropriate for carrying out the plan; and
a proposal unit that proposes at least one event among the extracted one or more events to the user, based on a result determined by the determination unit.

2. The information providing apparatus according to claim 1, wherein
the plan information includes consideration information on a first matter to be considered in carrying out the plan,
the one or more events include performance information on respective second matters that will occur in association with the performances of the one or more events; and
the determination unit determines whether or not the performances of the one or more events are appropriate based on a correspondence relation between the consideration information and the performance information.

3. The information providing apparatus according to claim 1, further comprising:
a customary plan estimating unit that acquires behavior history information to estimate, as the plan, custom information on a habituated behavior of the user, the behavior history information being a history of past behaviors recorded by the user, wherein
the extraction unit extracts the one or more events that are able to be performed by a start time point of the plan in the custom information estimated by the customary plan estimating unit.

4. The information providing apparatus according to claim 2, further comprising:
a customary plan estimating unit that acquires behavior history information to estimate, as the plan, custom information on a habituated behavior of the user, the behavior history information being a history of past behaviors recorded by the user, wherein
the extraction unit extracts the one or more events that are able to be performed by a start time point of the plan in the custom information estimated by the customary plan estimating unit.

5. The information providing apparatus according to claim 1, further comprising:
a reception unit that receives, when the at least one event is proposed by the proposal unit, an adequacy evaluation of the at least one event from the user, wherein
the proposal unit proposes at least one event among the extracted one or more events, based on the adequacy evaluation received by the reception unit.

6. The information providing apparatus according to claim 2, further comprising:
a reception unit that receives, when the at least one event is proposed by the proposal unit, an adequacy evaluation of the at least one event from the user, wherein
the proposal unit proposes at least one event among the extracted one or more events, based on the adequacy evaluation received by the reception unit.

7. The information providing apparatus according to claim 3, further comprising:
a reception unit that receives, when the at least one event is proposed by the proposal unit, an adequacy evaluation of the at least one event from the user, wherein
the proposal unit proposes at least one event among the extracted one or more events, based on the adequacy evaluation received by the reception unit.

8. The information providing apparatus according to claim 4, further comprising:
a reception unit that receives, when the at least one event is proposed by the proposal unit, an adequacy evaluation of the at least one event from the user, wherein
the proposal unit proposes at least one event among the extracted one or more events, based on the adequacy evaluation received by the reception unit.

9. The information providing apparatus according to claim 5, wherein
the proposal unit proposes the plurality of events, and
the reception unit receives adequacy evaluations of one or more events, among the plurality of events, which are not performed by the user.

10. The information providing apparatus according to claim 6, wherein
the proposal unit proposes the plurality of events, and
the reception unit receives adequacy evaluations of one or more events, among the plurality of events, which are not performed by the user.

11. The information providing apparatus according to claim 7, wherein
the proposal unit proposes the plurality of events, and
the reception unit receives adequacy evaluations of one or more events, among the plurality of events, which are not performed by the user.

12. The information providing apparatus according to claim 8, wherein
the proposal unit proposes the plurality of events, and
the reception unit receives adequacy evaluations of one or more events, among the plurality of events, which are not performed by the user.

13. The information providing apparatus according to claim 1, further comprising:
a decision unit that decides, when the extraction unit extracts the events, proposal preference orders of the respective events based on the result determined by the determination unit, wherein
the decision unit lowers a preference order of an event that is determined to be inappropriate by the determination unit, the event being among the extracted one or more events, and
the proposal unit proposes one or more events among the events extracted by the extraction unit, based on the preference orders decided by the decision unit.

14. The information providing apparatus according to claim 2, further comprising:
a decision unit that decides, when the extraction unit extracts the events, proposal preference orders of the respective events based on the result determined by the determination unit, wherein
the decision unit lowers a preference order of an event that is determined to be inappropriate by the determination unit, the event being among the extracted one or more events, and
the proposal unit proposes one or more events among the events extracted by the extraction unit, based on the preference orders decided by the decision unit.

15. The information providing apparatus according to claim 3, further comprising:
a decision unit that decides, when the extraction unit extracts the events, proposal preference orders of the respective events based on the result determined by the determination unit, wherein
the decision unit lowers a preference order of an event that is determined to be inappropriate by the determination unit, the event being among the extracted one or more events, and
the proposal unit proposes one or more events among the events extracted by the extraction unit, based on the preference orders decided by the decision unit.

16. The information providing apparatus according to claim 4, further comprising:
a decision unit that decides, when the extraction unit extracts the events, proposal preference orders of the respective events based on the result determined by the determination unit, wherein
the decision unit lowers a preference order of an event that is determined to be inappropriate by the determination unit, the event being among the extracted one or more events, and
the proposal unit proposes one or more events among the events extracted by the extraction unit, based on the preference orders decided by the decision unit.

17. The information providing apparatus according to claim 5, further comprising:
a decision unit that decides, when the extraction unit extracts the events, proposal preference orders of the respective events based on the result determined by the determination unit, wherein
the decision unit lowers a preference order of an event that is determined to be inappropriate by the determination unit, the event being among the extracted one or more events, and
the proposal unit proposes one or more events among the events extracted by the extraction unit, based on the preference orders decided by the decision unit.

18. The information providing apparatus according to claim 6, further comprising:
a decision unit that decides, when the extraction unit extracts the events, proposal preference orders of the respective events based on the result determined by the determination unit, wherein
the decision unit lowers a preference order of an event that is determined to be inappropriate by the determination unit, the event being among the extracted one or more events, and
the proposal unit proposes one or more events among the events extracted by the extraction unit, based on the preference orders decided by the decision unit.

19. An information providing method comprising:
acquiring plan information, the plan information being information on a plan to be carried out by a user;
extracting one or more events, the one or more events being able to be performed by a start time point of the plan in the plan information acquired in the acquiring;
determining, based on a type of the plan in the plan information acquired in the acquiring, whether or not performances of the one or more events extracted in the extracting are appropriate for carrying out the plan; and
proposing at least one event among the extracted one or more events to the user when the at least one event is determined to be appropriate in the determining.

20. A non-transitory computer-readable storage medium having stored therein an information providing program, the program causing a computer to execute a process comprising:
acquiring plan information, the plan information being information on a plan to be carried out by a user;
extracting one or more events, the one or more events being able to be performed by a start time point of the plan in the plan information acquired in the acquiring;
determining, based on a type of the plan in the plan information acquired in the acquiring, whether or not performances of the one or more events extracted in the extracting are appropriate for carrying out the plan; and
proposing at least one event among the extracted one or more events to the user when the at least one event is determined to be appropriate in the determining.
